(19) United States
(12) Patent Application Publication
(10) Pub. No.: US 2016/0134620 A1
(43) Pub. Date: May 12, 2016

(54) LOADING USER DEVICES WITH LISTS OF PROXIMATELY LOCATED BROADCAST BEACONS AND ASSOCIATED SERVICE IDENTIFIERS

(71) Applicant: CA, INC., New York, NY (US)

(72) Inventors: Kenneth William Scott Morrison, New Westminster (CA); Pei Qun (Anthony) Yu, Richmond (CA); Mike Lyons, Vancouver (CA); Efraim Moscovich, Teaneck, NJ (US); Anders Wilhelm Magnusson, Huntington, NY (US)

(73) Assignee: CA, INC., New York, NY (US)

(21) Appl. No.: 14/534,895

(22) Filed: Nov. 6, 2014

(51) Int. Cl. H04L 29/06; H04L 29/08

(52) U.S. Cl. CPC H04L 63/0823; H04L 67/146; H04L 67/42

(57) ABSTRACT

A user device transmits a location update message, indicating a location of the user device, to a network server. Responsive to the location update message, the user device receives from the network server a list of radio frequency beacons transmitted by resource devices and associated service identifiers for services available from the resource devices. A radio frequency beacon received from a resource device is identified as being in the list. A message is sent to the resource device requesting access to a service identified by a service identifier in the list associated with the radio frequency beacon and providing credentials for a user of the user device in the message.

### BACKGROUND

The present disclosure relates to distributed computer systems and, more particularly, to managing access to services within a distributed computer system.

The Internet has evolved to include a “physical Internet” including not only computers, but resource devices providing data processing, data sensing/generation, data communication, data storage, device control, user interface resources, etc. This evolution is sometimes referred to as “The Internet of Things”, “Ubiquitous Computing”, and “Pervasive Computing”. It has been estimated that every person is surrounded by somewhere between 1000 and 5000 intelligent resource devices and a global Internet of Things may soon include 50 to 100,000 billion resource devices whose location and status users may desire to monitor or use.

User can now operate user devices to access resource devices through short-range wireless networks, such as Bluetooth, Bluetooth Low Energy, Z-wave, and ANT. These resource devices include products that measure parameters associated with a user's physical activity and smart home appliances such as refrigerators with wireless data reporting, wireless controllable lighting, security systems with wireless controllability and/or data reporting, and wireless controllable thermostats. Other user devices connect through public networks (e.g., Internet) and/or private networks to network servers (e.g., the “Cloud”) to provide data processing services, data storage, data storage, and/or device control services, etc.

A user's ability to operate a user device to interface with more than a few networked resource devices at a time is limited by a lack of common and intuitive user interfaces with the myriad types of networked resource devices. Moreover, user devices are generally disabled from automatically reporting every new device discovery because of the excessive number of reports that would be generated by the high density of resource devices that has become commonplace.

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section.

### SUMMARY

Some embodiments disclosed herein are directed to a user device and, more particularly, a computer program product including a non-transitory computer readable storage medium comprising computer readable program code embodied in the medium. The program code, when executed by a processor of the user device, causes the processor to perform operations that include transmitting to a network server a location update message indicating a location of the user device. Responsive to the location update message, a list of radio frequency beacons transmitted by resource devices and associated service identifiers for services available from the resource devices, is received from the network server. A radio frequency beacon received from a resource device is identified as being in the list. A message is sent to the resource device requesting access to a service identified by a service identifier in the list associated with the radio frequency beacon and providing credentials for a user of the user device in the message.

Some other embodiments are directed to a network server and, more particularly, a computer program product including a non-transitory computer readable storage medium comprising computer readable program code embodied in the medium. The program code, when executed by a processor of the network server, causes the processor to perform operations that include receiving from a user device a location update message indicating a location of the user device. Resource devices proximately located to the location of the user device are identified. A list of radio frequency beacons transmitted by the resource devices and associated service identifiers for services available from the resource devices, is transmitted to the user device.

Some other embodiments are directed to a resource device and, more particularly, a computer program product including a non-transitory computer readable storage medium comprising computer readable program code embodied in the medium. The program code, when executed by a processor of the resource device, causes the processor to perform operations that include setting up a service session with a network server, and transmitting a radio frequency beacon. A secure Bluetooth connection is set up with a user device responsive to the radio frequency beacon. A session transfer message, requesting that the service session be transferred to the user device, is received from the user device. The session transfer message contains credentials for a user of the user device and identifies a service identifier. The session transfer message is sent to the network server. An encrypted service session identifier is received from the network server. The encrypted service session identifier has been encrypted by the network server using the credentials for the user. The encrypted service session identifier is forwarded to the user device. The service session is transferred from the resource device to the user device based on the service session identifier.

It is noted that aspects described with respect to one embodiment may be incorporated in different embodiments although not specifically described relative thereto. That is, all embodiments and/or features of any embodiments can be combined in any way and/or combination. Moreover, computer program products, methods, and electronic devices according to embodiments will be or become apparent to one with skill in the art upon review of the following drawings and detailed description. It is intended that all such additional computer program products, methods, and electronic devices be included within this description and protected by the accompanying claims.

### BRIEF DESCRIPTION OF THE DRAWINGS

Other features of embodiments will be more readily understood from the following detailed description of specific embodiments thereof when read in conjunction with the accompanying drawings, in which:

FIG. 1 is a block diagram of a computer system that includes a network server that uses the location and context mode information for a user device to send to the user device a list of radio frequency beacons transmitted by resource devices and associated service identifiers for services available from the resource devices, in accordance with some embodiments;

FIG. 2 is a combined data flow diagram and block diagram of operations by the network server, the resource device, and the user device, in accordance with some embodiments of the present disclosure;

FIG. 3 is a combined data flow diagram and flowchart of operations by a resource device for registering its beacon and associated service identifier with the network server, in accordance with some embodiments of the present disclosure;

FIG. 4 is a combined data flow diagram and flowchart of operations by a user device for registering with the network server, and operations by the network server for providing to the user device a list of beacons and associated service identifiers for resource devices that are proximately located to the user device, in accordance with some embodiments of the present disclosure;

FIG. 5 is a combined data flow diagram and flowchart of operations by the resource device, the user device, and the network server for granting the user device access to a service of the resource device, in accordance with some embodiments of the present disclosure;

FIG. 6 is a combined data flow diagram and flowchart of operations by the resource device, the user device, and the network server for causing a service session existing between the resource device and the network server to be transferred to between the user device and the network server, in accordance with some embodiments of the present disclosure;

FIG. 7 is a block diagram of a resource device and user device configured according to some embodiments of the present disclosure; and

FIG. 8 is a block diagram of an advertisement campaign computer configured according to some embodiments of the present disclosure.

### DETAILED DESCRIPTION

In the following detailed description, numerous specific details are set forth in order to provide a thorough understanding of embodiments of the present disclosure. However, it will be understood by those skilled in the art that the present invention may be practiced without these specific details. In other instances, well-known methods, procedures, components and circuits have not been described in detail so as not to obscure the present invention. It is intended that all embodiments disclosed herein can be implemented separately or combined in any way and/or combination.

As explained above, user devices are generally disabled from automatically reporting discovery of resource devices because of the excessive number of reports that would be generated by a high density of those resource devices that has become commonplace. Moreover, allowing user devices to continuous scan for presence of resource devices, such as via Bluetooth discovery mode, would substantially limit their battery life.

Various embodiments of the present disclosure are directed to managing how user devices identify and access services of resource devices. User devices and resource devices can register with a network server. A resource device can register its beacon identifier and identifiers for services that can be accessible to a user device having proper credentials. A user device can register its credentials with the network server. Responsive to location update messages from a user device, the network server can identify beacons of resource devices that are proximately located to the user device and can send a list of those beacons and associated service identifiers to the user device. The user device can then restrict its search and/or connection setup operations to the beacons within the list. The credentials can be used to confirm that the user device is authorized to access services associated with those service identifiers when the network server is generating the list. In this manner, a user of the user device may be automatically identified and authorized to use one or more services provided by the resource device. The resource device may transmit a Bluetooth Low Energy (BLE) beacon, and the user device resource device may set up a BLE protocol connection through which the user device requests and is granted access to one or more services on the resource device. The request and grant of access may be based on an authorization process performed by the network server using credentials provided by the user device.

In one non-limiting example embodiment, a cell phone operated by a user and two resource devices have registered with a network server. One resource device is a public computer monitor located in an airport terminal, and the other resource device is a private computer monitor located in a user's house. The public computer monitor and the private computer monitor can use BLE protocol radio frequency communication links to communicate with the cell phone. The public computer monitor and the private computer monitor each broadcast a beacon identifier to allow their discovery by the cell phone and other user devices. The network server includes a list of the beacons (beacon identifiers), identifiers of services provided by each computer monitor, information identifying locations of the beacons, and context mode information for the public computer monitor and the private computer monitor. The context mode information for the public computer monitor indicates it is located in a public area or otherwise used by many different users where presumably confidential information should not be displayed and/or recorded in memory. In contrast, the context mode information for the private computer monitor indicates it is located in a private area where confidential information can be displayed and/or recorded in memory.

The cell phone provides location updates to the network server, which the network server uses to determine when the cell phone has become proximately located to one or both of the public computer monitor and the private computer monitor. When determined to be proximate, the network server sends a list containing the beacon(s) for whichever or both of the proximately located computer monitors and their associated service identifiers. The user device uses information from the list to identify presence one or both of the computer monitors, set up a secure communication link thereto, and request access to the associated identified service(s). When the user device is proximate to the public computer monitor, it can automatically connect and use service(s) provided thereby, and can control the service selected and/or the type of information that it communicates through the service based on the context information indicating a public setting. Similarly, when the user device is proximate to the private computer monitor it can automatically connect and use service(s) provided thereby, and can control the service selected and/or the type of information that it communicates through the service based on the context information indicating a private setting.

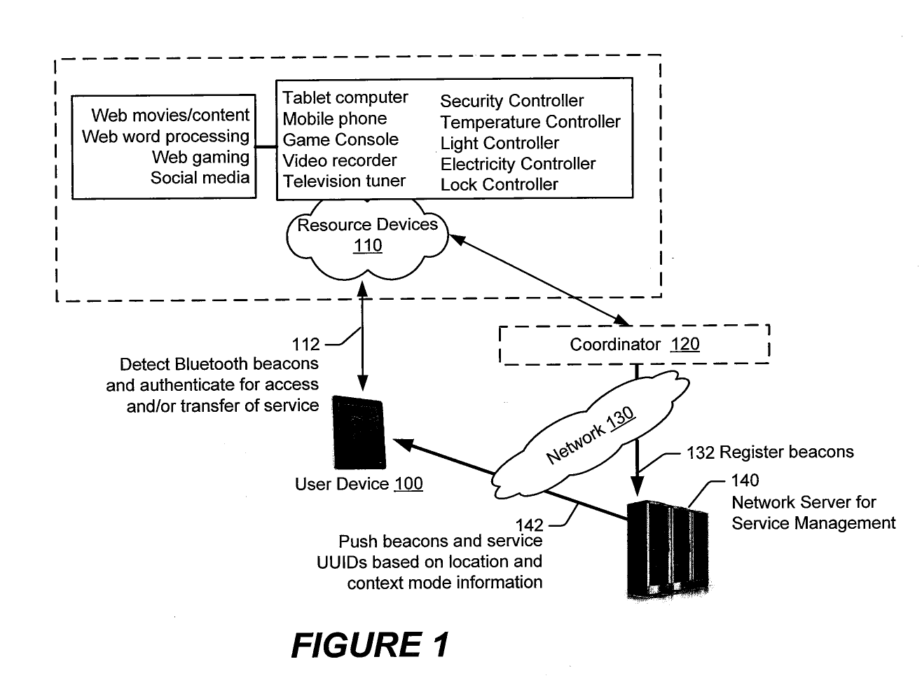

FIG. 1 is a block diagram of a computer system that includes a network server 140 that uses the location and context mode information for a user device 100 to send to the user device 100 a list of radio frequency beacons transmitted by resource devices 110 and associated service identifiers for services that available from the resource devices 110, in accordance with some embodiments. The radio frequency beacons, also referred to as “beacons” for brevity, may be identified by beacon identifiers according to the BLE protocol.

The resource devices 110 may include, without limitation, a desktop computer, a laptop computer, a tablet computer, a mobile phone, a game console, a video recorder, a television tuner, a security controller, a temperature controller, a light controller, an electrical controller, and a lock controller. One or more of the resource devices 110 may establish a service session with the network server 140 and/or other network servers (e.g., cloud servers) to provide network based services, such as movie and/or other entertainment content streaming and/or download services, word processing services, gaming services, and/or social media services. The user device 100 is operated by a user and may include, without limitation, a mobile computing device such as a tablet computer, a mobile phone, a game terminal, a video recorder and/or player, etc. The resource devices 110 broadcast radio frequency beacons, such as BLE beacons, which can be received and identified by the user device 100.

In accordance with some embodiments, the resource devices 110 and the user device 100 register with the network server 140 through one or more data networks 130. The data network(s) may include public networks, such as the Internet, and/or private network(s). A coordinator device 120 may be included that provides registration proxy services for one or more of the resource devices 110 and the network server 140. The coordinator device 120 may function as a communication hub between a personal area network and/or local area network with which the resource devices 110 communicate and the data network 130.

As will be explained in more detail below, the resource devices 110 register their beacons (beacon identifiers), service identifiers, and locations with the network server 140. The service identifiers can identify what services are available on the resource devices 110 for use by the user device 100. For example, a service identifier may identify a universally unique identifier (UUID) for an application program processed by the resource device 110 to which the user device 100 may be granted access or which may be transferred from the resource device 110 to the user device 100. The resource devices 110 may furthermore register context mode information with the network server 140 that identifies, for example, functionality, user access privileges, and/or device access privileges for services provided by the resource devices 110.

The user device 100 provides location updates to the network server 140, which responds by sending a list of radio frequency beacons transmitted by whichever of the resource devices 110 are determined to be proximately located to the user device 100 and identifies associated service identifiers for services available from the proximately located resource devices 110. A resource device 110 may be determined to be proximately located to the user device 100 based on estimating that the distance between them should be within range of their communication transceivers to allow establishment of a communication link between them. The network server 140 may furthermore select among the registered resource devices 110 based on matching context mode information provided for their services to context mode information provided by the user device 100 according to one or more defined rules controlling a needed level of similarity and/or differences between the context mode information to allow use of the service(s).

The user device 100 can then scan for presence of one or more of the beacons identified in the list, and when detected can establish a communication connection to the associated resource device(s) 110. The user device 100 may complete an authentication process to obtain access to the identified service on the resource device(s) 110 and/or to transfer the identified service session, which exists between the resource device(s) 110 and the network server 140 to alternatively or additionally be between the user device 100 and the network server 140.

As will be explained in further detail below, example operations that can be performed by the user device 100 can include transmitting to the network server 140 a location update message indicating a location of the user device. The user device 100 receives from the network server 140 responsive to the location update message, a list of radio frequency beacons transmitted by resource devices 110 and associated service identifiers for services available from the resource devices. The user device 100 identifies receipt of a radio frequency beacon in the list that is transmitted by a resource device 110. The user device 100 sends to the resource device 110 a message requesting access to a service identified by a service identifier in the list associated with the radio frequency beacon and providing credentials for a user of the user device 100 in the message.

Corresponding operations that can be performed by the network server 140 include receiving from the user device 100 a location update message indicating a location of the user device 100. The network server 140 identifies resource devices proximately located to the location of the user device 100, and transmits to the user device 100 a list of radio frequency beacons transmitted by the resource devices 110 and associated service identifiers for services available from the resource devices 110.

Corresponding operations that can be performed by a resource device 110 can include setting up a service session with the network server 140, and transmitting a radio frequency beacon. The resource device 110 sets up a secure Bluetooth connection with the user device 100, and receives from the user device 100 a session transfer message requesting that the service session be transferred to the user device 100. The session transfer message contains credentials for a user of the user device 100 and identifies a service identifier. The resource device 110 sends the session transfer message to the network server 140. Resource device 110 receives an encrypted service session identifier from the network server 140. The encrypted service session identifier is encrypted by the network server 140 using the credentials for the user. The resource device 110 forwards the encrypted service session identifier to the user device 100, and transfers the service session from the resource device 110 to the user device 100 based on the service session identifier.

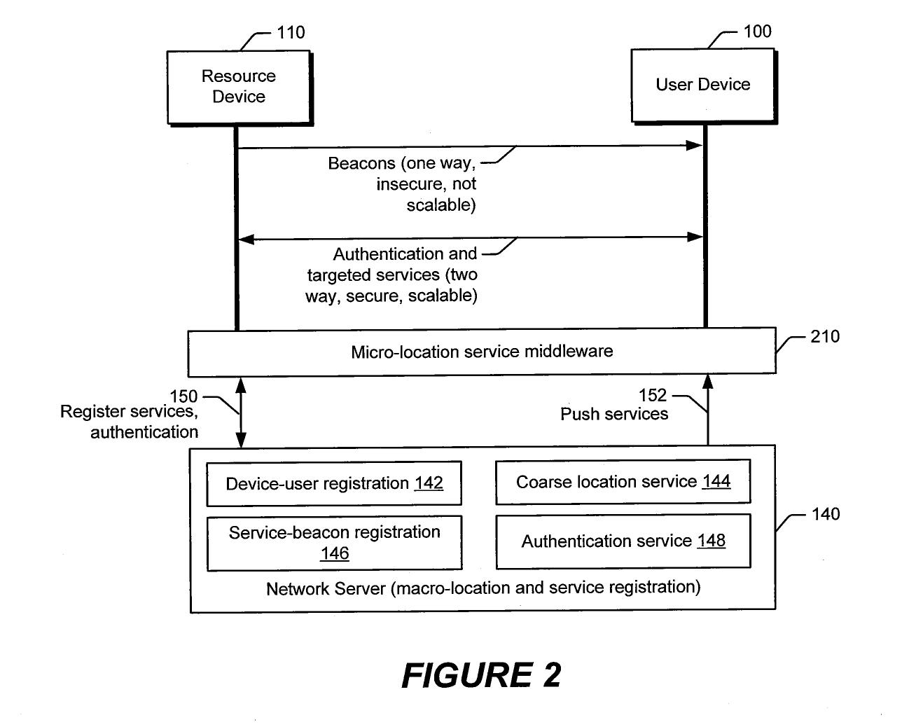

These and further operations by the user device 100, the network server 140, and the resource devices 110 are explained below with regard to FIGS. 2-8.

FIG. 2 is a combined data flow diagram and block diagram of operations by the network server 140, the resource device 110, and the user device 100, in accordance with some embodiments of the present disclosure. Referring to FIG. 2, the resource device 110 and the network server 142 exchange messages 150 to register beacons and services, and perform authentication. The resource device 110 registers its beacon identifier and one or more service identifiers with a service-beacon registration module 146 of the network server 140. The user of the user device 100 communicates other messages 150 to register the user's credentials and device information with a device-user registration module 142 of the network server 140. An authentication service module 148 of the network server 140 operates to authenticate messages received from the user device 100 and the resource device 110. The authentication service module 148 may authenticate the user device based on credentials of the user and device identifier, as will be explained in further detail below.

A coarse location service module 144 operates to determine a location of the user device 100. A location of the user device 100 may be determined using location information reported by the user device 100, which the user device 100 may determine using global positioning system satellite signaling and/or by obtaining location assistance from a cellular or other communication system. Alternatively or additionally, the location of the user device 100 may be determined using location information reported by a communication network, which may be determined using signal time of flight between the user device 100 and a plurality of radio transceiver base stations.

A micro location service middleware module 210 operates to more precisely determine the location of the user device 100 and its proximity to any resource devices 110 which have registered with the service-beacon registration module 146. The middleware module 210 may determine the location of the user device 100 based on WLAN network identifiers which are received by the user device 100 and reported to the middleware module 210. Operations of the middleware module 210 may reside at least partially within the network server 140, but may include operations of the user device 100 and the resource device 110.

The network server 140 pushes a list of beacons and service identifiers to the user device 100 through a message 152 in response to determining that the user device 100 is proximately located to the resource device 110 such that the user device 100 may receive one of the beacons within the list from the resource device 110, and establish a short-range communication link therewith to access the corresponding service identified in the list.

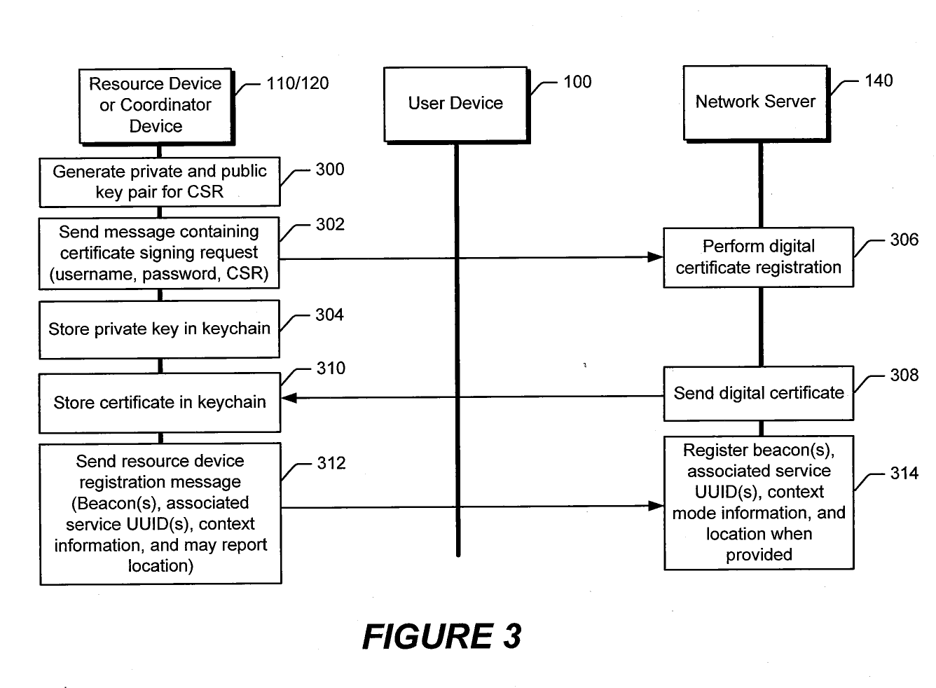

FIG. 3 is a combined data flow diagram and flowchart of operations by a resource device 110 for registering its beacon and associated service identifier of a resource device for addition to a list maintained by the network server, in accordance with some embodiments of the present disclosure. Operations explained as being performed by the resource device 110 may additionally or alternatively be performed by a coordinator device 120, which may be included in the system of FIG. 1 to serve as a proxy performing registration for a plurality of resource devices 110 with the network server 140.

The resource device 110 generates (block 300) a private key and public key pair for use with a certificate signing request (CSR). The resource device 110 sends (block 302) a message containing a CSR including the public key to the network server 140. The CSR may be accompanied by credentials (e.g., proofs of identity) used by the network server 140 to generate a digital certificate, or which is used by another certificate authority to generate a digital certificate. The credentials may include a username and password.

The network server 140 performs digital certificate registration (block 306), which may include communicating with a certificate authority server such as a VeriSign server. The certificate can include information about the public key, information about the user's identity, and the digital signature of an entity that has verified that the certificate's contents are valid. The resource device 110 stores (block 304) the private key in memory, such as by storing the private key in a programmatically organized keychain. The network server 140 sends (block 308) the digital certificate to the resource device 110, which stores (block 310) the certificate in memory associated with the private key, such as by storing the certificate in the keychain.

The resource device 110 sends (block 312) a resource device registration message to the network server 140. The registration message can include a beacon identifier for the resource device 110, service identifiers (e.g., UUIDs) for a software service processed by the resource device 110, and context mode information defining an operational characteristic of a service associated with the service identifier. The context mode information for a software service may identify, for example, functionality of the software service, user access privileges for obtaining access to the software service, and/or device access privileges for obtaining access to the software service provided by the resource device 110. The registration message may also report a location of the resource device 110. The location may be defined by geographic coordinates, a network address of the resource device, a network address of another electronic device within communication range of the resource device 110, and/or a network address for an edge router and/or a radio base station transceiver that communicates with the resource device 110.

The network server 140 receives the registration message, and registers (block 314) the beacon identifier, the service identifiers (e.g., UUIDs), and, when provided, the context mode information, and the location. The network server 140 similarly registers other resource devices 110, and may logically group the resource devices 110 based on the proximity between them. Registration operations by the network server 140 may include creating or adding to a list the radio frequency beacon identifiers, the service identifiers, and the locations of the resource devices 110. When context mode information for one of the resource devices 110 is provided, it can be added to the list with an association to the radio frequency beacon identifier for that resource device 110.

In one embodiment, operations performed by the network server 140 can include receiving from one of the resource devices a digital certificate registration message containing credentials for a user and a certificate signing request, registering a digital certificate for the one of the resource devices based on the credentials and the certificate signing request, transmitting the digital certificate to the one of the resource devices, receiving from the one of the resource devices a resource device registration message containing an radio frequency beacon identifier transmitted by the one of the resource devices and an associated service identifier for a service available from the one of the resource devices, and registering the radio frequency beacon identifier and the associated service identifier with the one of the resource devices.

In another embodiment, operations performed by the network server 140 can further include identifying a location of the one of the resource devices based on the resource device registration message. To register the radio frequency beacon identifier and the associated service identifier with the one of the resource devices, the network server 140 at the radio frequency beacon identifier, the service identifier, and the location of the one of the resource devices as entries in a list of registered ones of the resource devices. The network server 140 can then identify resource devices proximately located to the location of a user device 100 by searching the list of registered ones of the resource devices using the location of the user device 100.

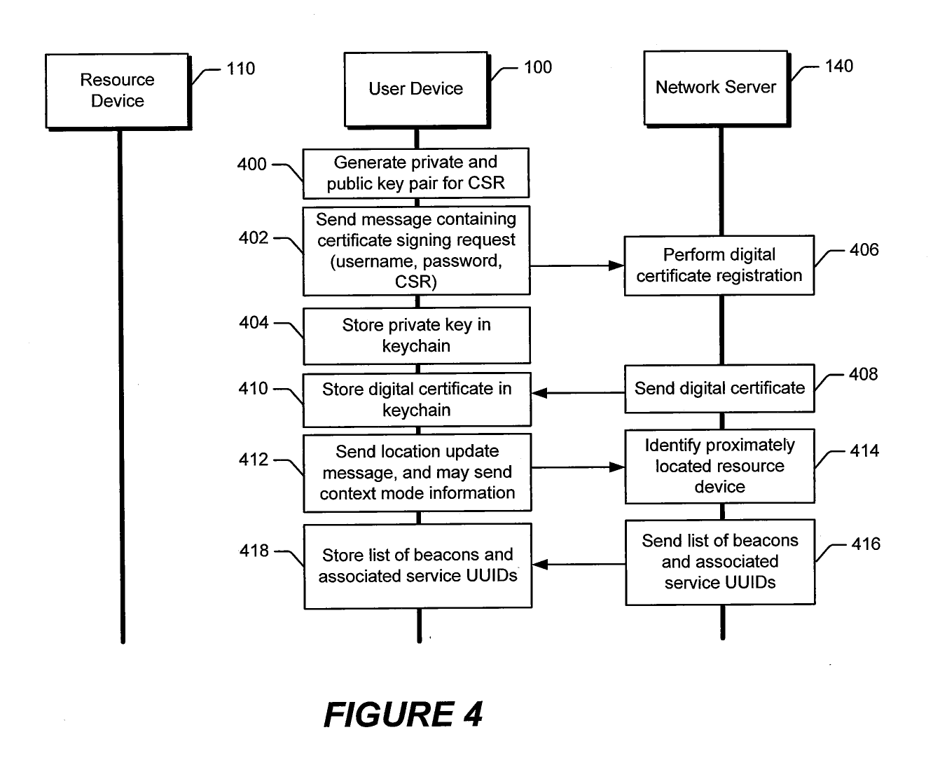

FIG. 4 is a combined data flow diagram and flowchart of operations by the user device 100 for registering with the network server 140, and operations by the network server 140 for providing to the user device 100 a list of beacons and associated service identifiers for resource devices that are proximately located to the user device 100, in accordance with some embodiments of the present disclosure. Referring to FIG. 4, the user device generates (block 400) a private key and public key pair for use with a CSR. The user device 100 sends (block 402) a message containing a CSR including the public key to the network server 140. The CSR may be accompanied by credentials (e.g., proof of identity) which is used by the network server 140 to generate a digital certificate, or which is used by another certificate authority to generate a digital certificate. The credentials may include a username and password.

The network server 140 performs digital certificate registration (block 406), which may include communicating with a certificate authority server such as a VeriSign server. The certificate can include information about the public key, information about the user's identity, and the digital signature of an entity that has verified that the certificate's contents are valid. The user device 100 stores (block 404) the private key in memory, such as by storing the private key in a programmatically organized keychain. The network server 14Q sends (block 408) the digital certificate to the user device 100, which stores (block 410) the certificate in memory associated with the private key, such as by storing the certificate in the keychain.

The user device 100 transmits (block 412) a location update message indicating a location of the user device 100, to the network server 140. The location update message may report the location defined as geographic coordinates, a network address of the user device 100, a network address of another electronic device within communication range of the user device 100, and/or a network address for an edge router and/or a radio base station transceiver that communicates with the user device 100.

The location update message may further include context mode information defining an operational characteristic or other mode of the user device. The context mode information may, for example, identify access privileges of the user and/or user device 100 have defined for accessing services and/or transferring services on resource devices 110. Alternatively or additionally, the context mode information may identify the present state of the user device 100 such as movement (e.g., indication of speed), identify one or more services presently being processed by the user device 100, identify one or more application settings defined in the user device 100 (e.g., alert notification mode such as ringer level and/or vibration setting, sleep mode, etc.), and/or an indicate of a present level of user interaction with the user device 100.

The network server 140 receives the location update message and identifies (block 414) any resource devices that have registered with the network server 140 and which are determined to be proximately located to the user device 100. The network server 140 may identify resource devices proximately located to the location of the user device 100 by searching the list of registered ones of the resource devices 110 using the reported location of the user device 100. The network server 140 may also search the list using context mode information, if received in the location update message, which identifies an operational mode of the user device 100 to identify any matches to context mode information associated with the resource devices in the list. The network server 140 may thereby generate a list of beacons (beacon identifiers) for resource devices within the list that are proximately located to the user device 100 and which have context mode information for services provided by the resource devices that matches the context mode information of the user device 100. A match may be determined by the network server 140 to occur when the context mode information for a service and for the user device 100 satisfy one or more defined rules for similarity or differences.

The network server 140 sends (block 416) a list of beacons and associated service identifiers (e.g., UUIDs) to the user device 100. The user device 100 receives and stores (block 418) the list of beacons and associated service identifiers in memory. The network server 140 may authenticate the location update message based on the digital certificate, and selectively perform the identification of proximately located resource devices 110 based on the authenticating.

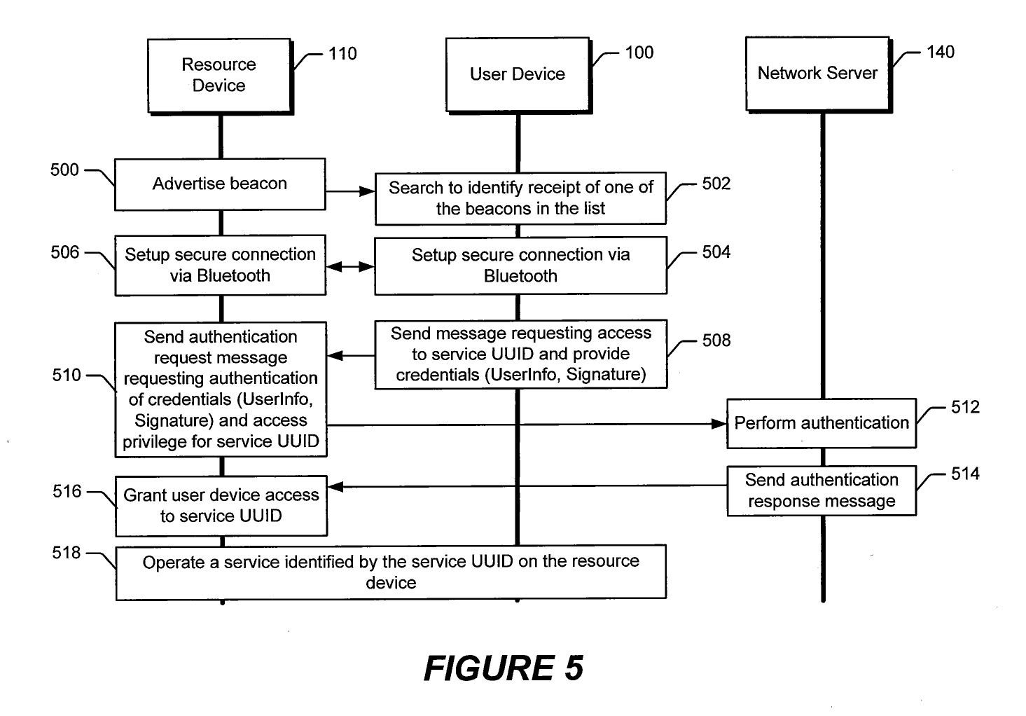

FIG. 5 is a combined data flow diagram and flowchart of operations by the resource device 110, the user device 100, and the network server 140 for granting the user device 100 access to a service of the resource device 110, in accordance with some embodiments of the present disclosure. Referring to FIG. 5, the resource device 110 advertises (block 500) its beacon by transmitting through a broadcast of the radio frequency beacon. The user device 100 searches (block 502) to identify receipt of one of the radio frequency beacons in the list from the network server 140 which is now stored in memory. The user device 100 may search (block 502) for the radio frequency beacon based on a Bluetooth Low Energy protocol. When identifying receipt of one of the radio frequency beacons in the list, the user device 100 can search to identify the radio frequency beacons in the list while disregarding other radio frequency beacons that are not in the list.

Responsive to identifying receipt of the beacon from the resource device 110 which is determined to be among the beacons in the list, the user device 100 and the resource device 110 set up (blocks 504 and 506) a secure connection via Bluetooth low energy (BLE) and/or another radio frequency protocol, such as WLAN, Z-wave, and/or ANT originally developed by Dynastream Innovations, Inc.

The user device 100 sends (block 508) a message requesting access to the service identifier (e.g., UUID) defined in the list as being associated with the identified beacon, and provides credentials which can include user information and a signature. In one embodiment, the user device 100 generates the signature using the digital certificate from the network server 140 and the private key it earlier generated (block 400). The credentials sent to the resource device 110 can be generated based on the signature. The user device 100 may send the message using a BLE protocol.

The resource device 110 receives the message and generates an authentication request message which it sends (block 510) to the network server 140 requesting authentication of the credentials. The authentication request message can include the credentials, such as user information and signature, and access privilege information for the service identifier. The network server 140 performs authentication (block 512) and sends (block 514) an authentication response message to the resource device 110.

The resource device 110 grants (block 516) user device access to the service identifier (e.g., UUID) based on the authentication response message. The user device 100 then communicates with the resource device 110 to operate (block 518) a service identified by the service identifier (e.g., UUID) processed by the resource device 110. To operate (block 518) the identified service, the user device 100 can establish communications between an application program processed by the user device 100 and an application program identified by the service identifier that is processed by the resource device 110.

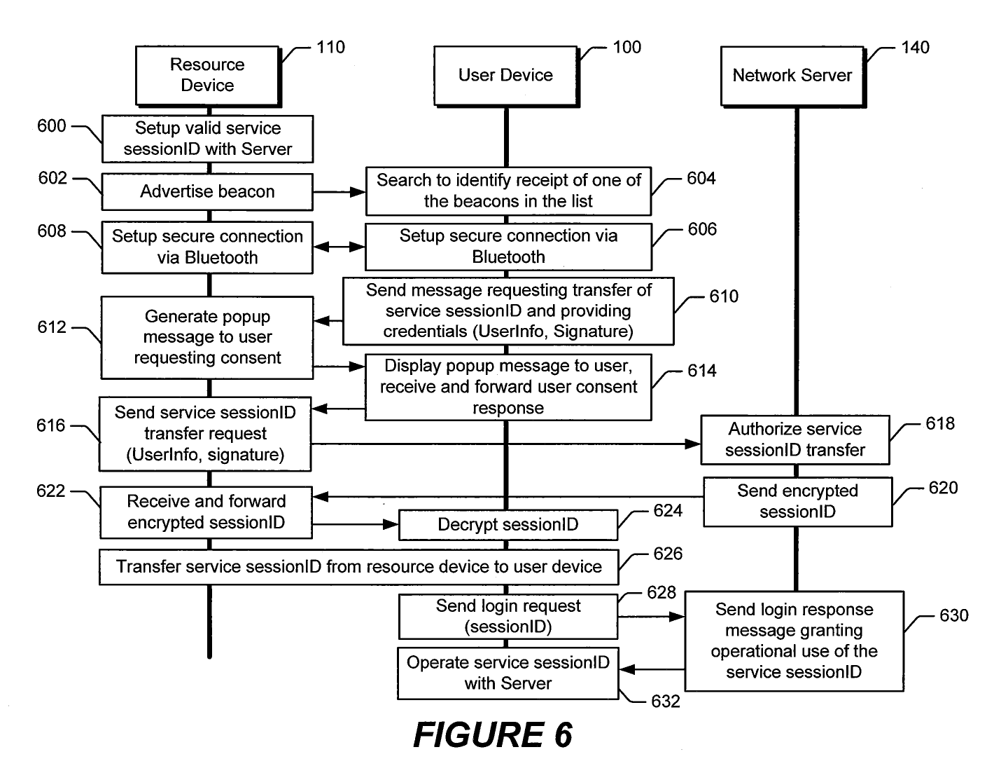

FIG. 6 is a combined data flow diagram and flowchart of operations by the resource device 110, the user device 100, and the network server 140 for causing a service session existing between the resource device 110 and the network server 140 to be transferred to between the user device 100 and the network server 140, in accordance with some embodiments of the present disclosure. Referring to FIG. 6, the resource device 110 sets up (block 600) a valid service session, identified as sessionID, with the network server 140. For example, the service sessionID may correspond to a web service, such as a movie and/or other entertainment content streaming and/or download service session, word processing service session, gaming service session, and/or social media service session between the resource device 110 and the network server 140 or another network server.

The resource device 110 advertises (block 602) its beacon by transmitting the radio frequency beacon. The user device 100 searches (block 604) to identify receipt of one of the radio frequency beacons in the list from the network server 140 and now stored in memory. The user device 100 may search (block 604) for the radio frequency beacon based on a BLE protocol. When identifying receipt of one of the radio frequency beacons in the list, the user device 100 can search to identify the radio frequency beacons in the list while disregarding other radio frequency beacons that are not in the list.

Responsive to identifying receipt of the beacon from the resource device 110 which is determined to be among the beacons in the list, the user device 100 and the resource device 110 set up (blocks 606 and 608) a secure connection via BLE and/or another radio frequency protocol, such as NFC.

The user device 100 sends (block 610) a message requesting that a service session for sessionID that is presently provided by the network server 140 to the resource device be transferred to the user device 100. The user device 100 identifies service sessionID based on the list which indicates that the service sessionID is associated with the identified beacon. The message contains credentials which can include user information and a signature. In one embodiment, the user device 100 generates the signature using the digital certificate from the network server 140 and the private key it earlier generated (block 400). The credentials sent to the resource device 110 can be generated based on the signature. The user device 100 may send the message using a BLE protocol.

The resource device 110 receives the message and may generate (block 612) a request for user consent, such as a pop-up message, for transfer of the service sessionID. The user device 100 performs responsive operations (block 614) to display the request for user consent (e.g., pop up message) to the user, and receive and forward a user consent response to the resource device 110.

The resource device 110 sends (block 616) a service session transfer message to the network server 140 requesting authorization for transfer of the service sessionID. The service session transfer message may include credentials for the user, such as user information and the signature. The network server 140 authorizes (block 618) the service session transfer based on information in the message, such as based on the credentials. The network server 140 sends (block 620) an encrypted sessionID to the resource device 110, which may be encrypted using the credentials for the user. Resource device 110 receives and forwards (block 622) the encrypted sessionID to the user device 100. The user device 100 decrypts (block 624) the service sessionID using the credentials, such as based on using the private key stored in the user device 100.

The user device 100 and the resource device 110 may perform operations (block 626) to transfer the service sessionID from the resource device 110 to the user device 100. The user device 100 may send (block 628) a login request identifying the service sessionID to the network server 140. The network server 140 communicates (block 630) a login response granting the user device 100 operational use of the service session based on the login request. The user device 100 communicates (block 632) with the network server 140 to operate the service sessionID.

As used herein, the term “transmission” includes wireless and wireline communications. Accordingly, a message may be transmitted through a radio frequency communication link or transmitted through a wired network connection such as an electrical or optical cable.

### Example Resource Device, User Device, and Network Server

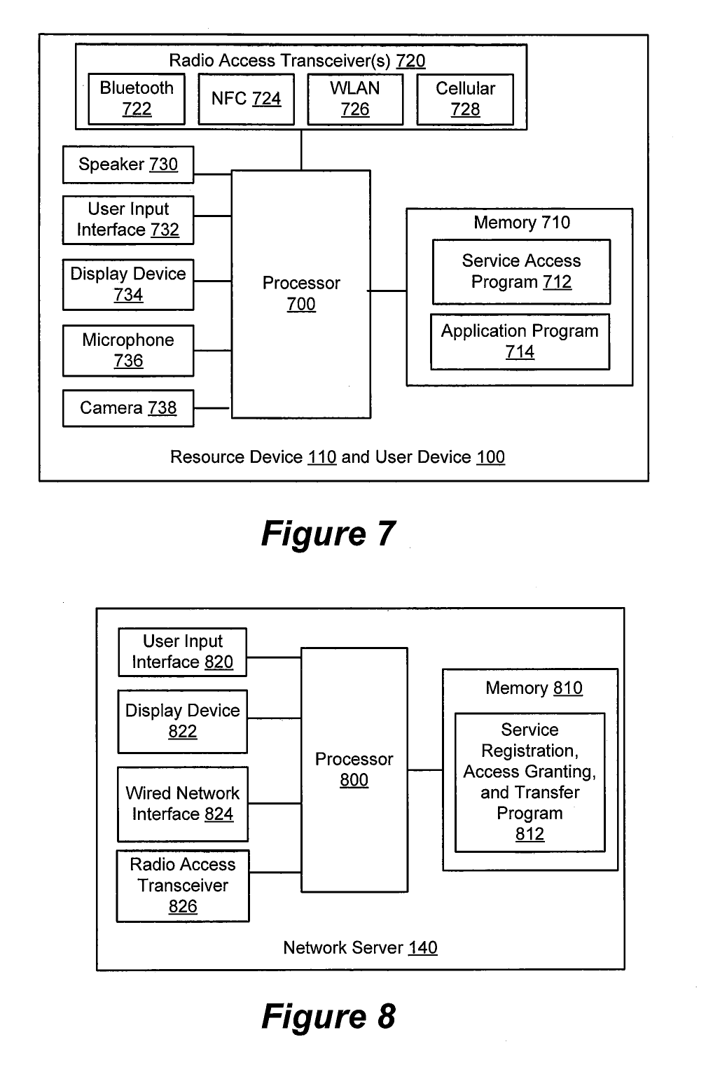

FIG. 7 is a block diagram of electronic circuit components that may be used in a resource device 110 and a user device 100 according to some embodiments of the present disclosure. Referring to FIG. 7, the electronic circuit components includes a processor 700, a memory 710, and one or more radio access transceivers 720. The radio access transceivers 720 may include a Bluetooth transceiver 722, a near field communication transceiver 724, a wireless local area network transceiver 726 (e.g., IEEE 802.11), a cellular transceiver 728 (e.g., LTE), and/or other radio transceiver such as Z-wave transceiver or an ANT transceiver. The Bluetooth transceiver 722 may operate according to Bluetooth 4.0 and/or a related Bluetooth standard, which may also be referred to as Bluetooth Low Energy and/or Bluetooth Smart.

The processor 700 may include one or more data processing circuits, such as a general purpose and/or special purpose processor, such as a microprocessor and/or digital signal processor. The processor 700 is configured to execute computer program code in the memory 710, described below as a non-transitory computer readable medium, to perform at least some of the operations described herein as being performed by a user device. The computer program code may include an application program 714 and a service access program 712 configured to perform at least some of the operations disclosed herein when the electronic circuit components are incorporated in the respective resource device 110 or the user device 100. The computer program code when executed by the processor 700 causes the processor 700 to perform operations in accordance with one or more embodiments disclosed herein for the resource device 110 or the user device 100.

The electronic circuit components may further include a speaker 730, user input interface 732 (e.g., touch screen, keyboard, keypad, etc.), a display device 734, a microphone 736, and a camera 738. As used herein, the term “user device” may include a cellular radiotelephone, satellite radiotelephone, a gaming console, a smart appliance, a tablet computer, a laptop computer, and/or a desktop computer.

FIG. 8 is a block diagram of a network server 140 configured according to some embodiments of the present disclosure. The network server 140 includes a processor 800, a memory 810, and a network interface which may include a radio access transceiver 826 and/or a wired network interface 824 (e.g., Ethernet interface, cable modem interface, digital subscriber line interface, etc.). The radio access transceiver 826 can include, but is not limited to, a Bluetooth transceiver, a near field communication transceiver, a WLAN transceiver, a cellular transceiver, and/or other radio transceiver such as Z-wave transceiver or an ANT transceiver. The Bluetooth transceiver 722 may operate according to Bluetooth 4.0 and/or a related Bluetooth standard, which may also be referred to as Bluetooth Low Energy and/or Bluetooth Smart. The network interface is configured to communicate with the user device 100 and the resource device 110 via one or more wired networks and/or radio access networks.

The processor 800 may include one or more data processing circuits, such as a general purpose and/or special purpose processor (e.g., microprocessor and/or digital signal processor) that may be collocated or distributed across one or more networks. The processor 800 is configured to execute computer program code 812 in the memory 810, described below as a non-transitory computer readable medium. The computer program code 812 when executed by the processor 800 causes the processor 800 to perform operations in accordance with one or more embodiments disclosed herein for the network server 140. The network server 140 may further include a user input interface 820 (e.g., touch screen, keyboard, keypad, etc.) and a display device 822.

### Further Definitions and Embodiments

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented in entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

It is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A computer program product, comprising:
a non-transitory computer readable storage medium comprising computer readable program code embodied in the medium that when executed by a processor of a user device causes the processor to perform operations comprising:
transmitting to a network server a location update message indicating a location of the user device;
receiving from the network server responsive to the location update message, a list of radio frequency beacons transmitted by resource devices and associated service identifiers for services available from the resource devices;
identifying that a radio frequency beacon is received from a resource device in the list; and
sending to the resource device a message requesting access to a service identified by a service identifier in the list associated with the radio frequency beacon and providing credentials for a user of the user device in the message.

2. The computer program product of claim 1, prior to transmitting the location update message further comprising:
generating a private key and a public key pair;
sending to the network server a message containing credentials for the user and a certificate signing request containing the public key;
receiving a digital certificate from the network server;
generating a signature based on the digital certificate and the private key; and
generating the credentials in the message sent to the resource device based on the signature.

3. The computer program product of claim 1, wherein:
the identifying that a radio frequency beacon is received from a resource device in the list, comprises searching for the radio frequency beacon based on a Bluetooth Low Energy protocol; and
the sending to the resource device a message requesting access to a service identified by a service identifier in the list, comprises sending the message based on the Bluetooth Low Energy protocol through a transceiver to the resource device.

4. The computer program product of claim 1, wherein the identifying receipt of one of the radio frequency beacons in the list, comprises:
searching to identify the radio frequency beacons in the list while disregarding other radio frequency beacons that are not in the list.

5. The computer program product of claim 1, wherein the service identifiers for services available from the resource devices each comprise a universally unique identifier (UUID) for an application program processed by the user terminal.

6. The computer program product of claim 1, further comprising:
operating a service identified by the service identifier on the resource device.

7. The computer program product of claim 6, wherein the operating the service identified by the service identifier on the resource device, comprises:
establishing communications between an application program processed by the user device and an application program identified by the service identifier that is processed by the resource device.

8. The computer program product of claim 1, wherein the sending to the resource device the message requesting access to a service identified by the service identifier in the list associated with the radio frequency beacon, comprises:
requesting through the message that a service session associated with the service identifier that is presently provided by the network server to the resource device be transferred to the user device.

9. The computer program product of claim 8, further comprising:
receiving a service session identifier from the resource device responsive to the message; and
transferring the service session from the resource device to the user device based on the service session identifier.

10. The computer program product of claim 9, wherein the receiving the service session identifier from the resource device responsive to the message, comprises:
receiving an encrypted service session identifier from the resource device responsive to the message, the encrypted service session identifier being encrypted by the network server using the credentials for the user and provided through the resource device to the user device; and
decrypting the encrypted service session identifier using the credentials for the user to output the service session identifier.

11. The computer program product of claim 10, further comprising:
generating a private key and a public key pair;
sending to the network server a message containing credentials for the user and a certificate signing request containing the public key;
receiving a digital certificate from the network server; and
generating a signature based on the digital certificate and the private key,
wherein the decrypting the encrypted service session identifier using the credentials for the user to output the service session identifier, comprises:
decrypting the encrypted service session identifier using the private key.

12. The computer program product of claim 9, wherein the transferring the service session from the resource device to the user device based on the service session identifier, comprises:
sending a login request containing the service session identifier to the network server;
receiving a login response from the network server granting access to the service session provided by the network server; and
operating the service session provided by the network server.

13. A computer program product, comprising:
a non-transitory computer readable storage medium comprising computer readable program code embodied in the medium that when executed by a processor of a network server causes the processor to perform operations comprising:
receiving from a user device a location update message indicating a location of the user device;
identifying resource devices proximately located to the location of the user device; and
transmitting to the user device a list of radio frequency beacons transmitted by the resource devices and associated service identifiers for services available from the resource devices.

14. The computer program product of claim 13, prior to receiving the location update message further comprising:
receiving from the user device a message containing credentials for a user and a certificate signing request containing the public key;
registering a digital certificate for the user device; and
transmitting the digital certificate to the user device,
wherein the receiving from a user device a location update message indicating a location of the user device, comprises:
authenticating the location update message based on the digital certificate; and
selectively performing the identifying resource devices based on the authenticating.

15. The computer program product of claim 14, prior to receiving the location update message further comprising:
receiving from one of the resource devices a digital certificate registration message containing credentials for a user and a certificate signing request;
registering a digital certificate for the one of the resource devices based on the credentials and the certificate signing request;
transmitting the digital certificate to the one of the resource devices;
receiving from the one of the resource devices a resource device registration message containing an radio frequency beacon identifier transmitted by the one of the resource devices and an associated service identifier for a service available from the one of the resource devices; and
registering the radio frequency beacon identifier and the associated service identifier with the one of the resource devices.

16. The computer program product of claim 15, wherein:
the resource device registration message further identifies a location of the one of the resource devices;
the registering the radio frequency beacon identifier and the associated service identifier with the one of the resource devices, comprises adding the radio frequency beacon identifier, the service identifier, and the location of the one of the resource devices as entries in a list of registered ones of the resource devices; and
the identifying resource devices proximately located to the location of the user device comprises searching the list of registered ones of the resource devices using the location of the user device.

17. The computer program product of claim 16, wherein:
the resource device registration message further includes context mode information defining an operational characteristic of a service associated with the service identifier;
the registering the radio frequency beacon identifier and the associated service identifier with the one of the resource devices, comprises adding the context mode information as an entry in the list with an association to the radio frequency beacon identifier, the service identifier, and the location of the one of the resource devices;
the location update message includes context mode information identifying an operational mode of the user device;
the identifying resource devices proximately located to the location of the user device comprises searching the list of registered ones of the resource devices using the location of the user device, and using the context mode information identifying an operational mode of the user device to identify matches to context mode information associated with the resource devices.

18. The computer program product of claim 13, further comprising:
receiving from one of the resource devices a session transfer message requesting that a service session presently provided by the network server to the one of the resource devices be transferred to the user device, the session transfer message containing credentials for a user of the user device and identifying one of the service identifiers in the list corresponding to the service session;
authorizing the transfer based on the credentials for the user of the user device;
sending a service session identifier, corresponding to the one of the service identifiers of the service session, to the one of the resource devices for forwarding to the user device; and
communicating with the user device to transfer access to the service session from the one of the resource devices to the user device using the service session identifier.

19. The computer program product of claim 18, wherein the communicating with the user device to transfer access to the service session from the one of the resource devices to the user device using the service session identifier, comprises:
receiving a login request from the user device, the log request identifying the service session identifier;
granting the user device operational use of the service session based on the login request.

20. A computer program product, comprising:
a non-transitory computer readable storage medium comprising computer readable program code embodied in the medium that when executed by a processor of a resource device causes the processor to perform operations comprising:
setting up a service session with a network server;
transmitting a radio frequency beacon;
setting up a secure Bluetooth connection with a user device responsive to the radio frequency beacon;
receiving from the user device a session transfer message requesting that the service session be transferred to the user device, the session transfer message containing credentials for a user of the user device and identifying a service identifier;
sending the session transfer message to the network server;
receiving an encrypted service session identifier from the network server, the encrypted service session identifier being encrypted by the network server using the credentials for the user;
forwarding the encrypted service session identifier to the user device; and
transferring the service session from the resource device to the user device based on the service session identifier.
